(19) United States
(12) Patent Application Publication
(10) Pub. No.: US 2004/0012960 A1
(43) Pub. Date: Jan. 22, 2004

(54) Colorful bulb assembly

(76) Inventor: Kuo-Fen Shu, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/195,487

(22) Filed: Jul. 16, 2002

(51) Int. Cl. F21V 21/00

(52) U.S. Cl. 362/249

(57) ABSTRACT

The present invention relates to a colorful bulb assembly, which includes a bulb holder connecting with a bulb and a shell mounted around the bulb. The characteristic is that the bulb is painted with two or more than two colors and the shell is transparent or semi-transparent. The painted bulb can emit colorful light through the shell for a special decorative purpose.

### BACKGROUND OF THE INVENTION

A bulb assembly includes a bulb holder connecting with a bulb, which can light for decorative effect. In order to provide various displays, a shell, which can be mono-color or multi-color, is provided around the bulb that produces colorful outlook through the shell.

The primary object of the invention is to provide a novel and invented colorful bulb assembly, which has a colorful bulb with a transparent or semi-transparent shell for achieving a multi-color effect with improvement. Now the features and advantages of the present invention will be described in detail with reference to the accompanying drawings.

### BRIEF DESCRIPTION OF ACCOMPANYING DRAWINGS

FIG. 1 is an exploded perspective view showing a colorful bulb assembly according to the present invention.

FIG. 2 is an assembled perspective view showing a colorful bulb assembly of FIG. 1.

### DETAILED DESCRIPTION OF PREFERRED EMBODIMENTS

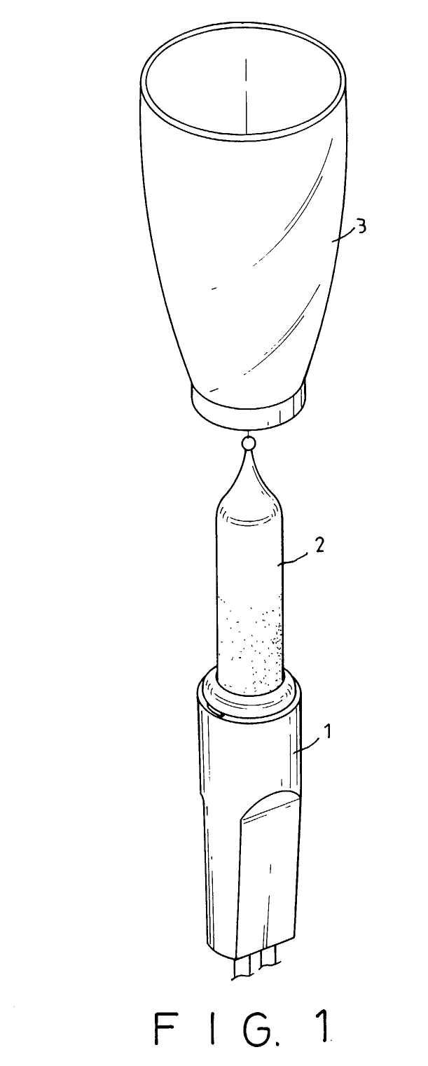

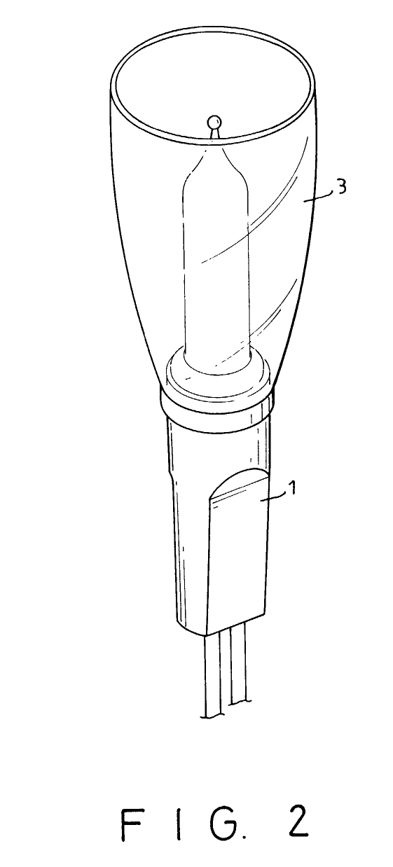

Please refer to FIGS. 1 and 2, the present invention mainly includes a bulb holder (1) connecting with a bulb (2) and a shell (3) mounted around the bulb (2). The characteristic of the present invention is to paint the bulb (2) with two or more than two colors, in this embodiment is two colors. The shell (3) is transparent or semi-transparent.

Under such assembly, the bulb (2) emits colorful light since it is covered with various paints. The colorful light can also emit through the transparent or semi-transparent shell, which becomes a new colorful bulb assembly.

Accordingly, the assembly of the present invention, which utilizes the colorful bulb and transparent or semi-transparent shell to provide such a decorative product, obviously achieves utility and improvement.

What is claimed is:

1. A colorful bulb assembly including a bulb holder connecting with a bulb and a shell mounted around the bulb, and the characteristic is that the bulb being painted with two or more than two colors while the shell being transparent or semi-transparent.
